(19) United States
(12) Patent Application Publication
(10) Pub. No.: US 2013/0228562 A1
(43) Pub. Date: Sep. 5, 2013

(54) HEATER SEWN ON CLOTHES

(71) Applicant: Chien-Chou CHEN, Tainan (TW)

(72) Inventor: Chien-Chou CHEN, Tainan (TW)

(21) Appl. No.: 13/410,390

(22) Filed: Mar. 2, 2012

(51) Int. Cl. H05B 1/00

(52) U.S. Cl. 219/211

(57) ABSTRACT

A heater sewn on clothes is revealed. The heater includes a cover layer sewn on clothes and a heating unit. The cover layer consists of an inner layer, an outer layer, and an intermediate layer between the inner layer and the outer layer. The heating unit is arranged at the intermediate layer. Each side of the inner layer and of the outer layer forming the intermediate layer is disposed with a waterproof membrane having a high melting point. One end of each conductive wire connected to a high resistance filament includes at least two strands of electric filaments wound around and connected to the high resistance filament. The waterproof membranes are melted by high temperature and high pressure treatment so as to make the waterproof membranes of the heating unit and of the cover layer connect with each other and achieve water resistance.

### BACKGROUND OF THE INVENTION

1. Field of the Invention

The present invention relates to a heater, especially to a heater sewn on clothes having a stable connection and higher heating performance.

2. Description of Related Art

In order to keep warm in a cold weather, people wear thick and heavy clothes and feel uncomfortable. The clothes also cause trouble in storage. Thus various devices including disposable heat pads, pocket warmers, or heating bags are provided for getting additional heat. However, these devices can only keep local areas warm and the heating temperature can't be adjusted. Moreover, they stay hot for a short period and the heat preservation is poor.

Refer to U.S. Pat. No. 7,105,782, an electrothermal article is revealed. The electrothermal article includes a plurality of heating elements disposed in an inner space between two fabric sheets. An adhesive layer is for bonding intermediate portions of the heating elements to the fabric sheets. Such design is not only time-consuming and labor-intensive during manufacturing processes but also leading to increasing cost. Moreover, the adhesive layer made from an adhesive material having a low melting point is easy to be melted while the heating elements working. Thus the adhesion is not stable and not strong enough. Furthermore, the heating elements are not fixed or separated by any other parts besides the adhesive layer. Once the heating elements fall off from the fabric sheet due to melted adhesive layer or washing, the heating elements are not distributed over the fabric sheets. Thus the heat supply is uneven and the efficiency is reduced.

Refer to U.S. Pat. No. 7,135,036, a heating pad is disclosed. The heating pad includes an envelope containing a metal plate and a resistance heating element attached to the metal plate. Once an opening of the envelope is open, water may infiltrate during washing processes. Thus the metal plate with the resistance heating element gets damaged.

Refer to U.S. Pat. No. 6,573,48, an electrical heating wire assembly is disclosed. The electrical heating wire assembly includes a heating wire with electrical heating filaments, a conductive wire, and a connector interconnecting the heating wire and a conductive wire. The connector is composed of a conductive body having a block portion and a pin portion projecting from the block portion into the heating wire to contact the heating filaments. An insulator sleeve is sleeved on the conductive body, ends of the heating wire and the conductive wire. Only a part of the heating filaments inside are in contact with the pin portion while the heating filaments outside are not connecting with the pin terminal. Thus a high temperature hot spot occurs around this area due to high resistance while current flowing from the conductive wire to the electrical heating filaments. The current is not conducted well to flow through the whole heating filament. Therefore the temperature of the heating filament is lower than the connection area between the contact area between the heating filaments and the pin portion and the heating is not ideal.

Thus there is room for improvement and a need to provide a novel heater on clothes that overcomes the above shortcomings.

### SUMMARY OF THE INVENTION

Therefore it is a primary object of the present invention to provide a heater sewn on clothes, having a stable connection and with better heating efficiency.

In order to achieve the above object, a clothes heater according to the present invention includes a cover layer and a heating unit.

The cover layer consists of an inner layer, an outer layer and an intermediate layer formed between the inner layer and the outer layer. One side of the inner layer and one side of the outer layer that form the intermediate layer are respectively disposed with a layer of waterproof membrane having a high melting point. The thickness of the inner layer is smaller than the thickness of the outer layer.

The heating unit is placed at the intermediate layer and is composed of a high resistance filament and conductive wires connected to the high resistance thread. One end of the conductive wire connected to the high resistance filament is divided into at least two strands of electric filaments, respectively wound around the high resistance filament. The other end of each conductive wire is extended out from the cover layer to be electrically connected with a controller and a power supply unit respectively.

The waterproof membrane with the high melting point is belt by high temperature and high pressure treatment. Thus the heating unit is connected to the waterproof membrane of the cover layer and water resistance is achieved. Moreover, the conductive wires of the heating unit are connected to the high resistance filament by strands of electric filaments so as to reduce resistance between the high resistance filament and the conductive wire. Thus thermal efficiency of the heating unit is increased.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective view of an embodiment according to the present invention;

FIG. 2 is an explosive view of an embodiment according to the present invention;

FIG. 3 is a partial enlarged view of a heating unit of an embodiment according to the present invention;

FIG. 4 is a perspective assembly view of an embodiment according to the present invention;

FIG. 5 is a cross sectional view of an embodiment according to the present invention.

### DETAILED DESCRIPTION OF THE PREFERRED EMBODIMENT

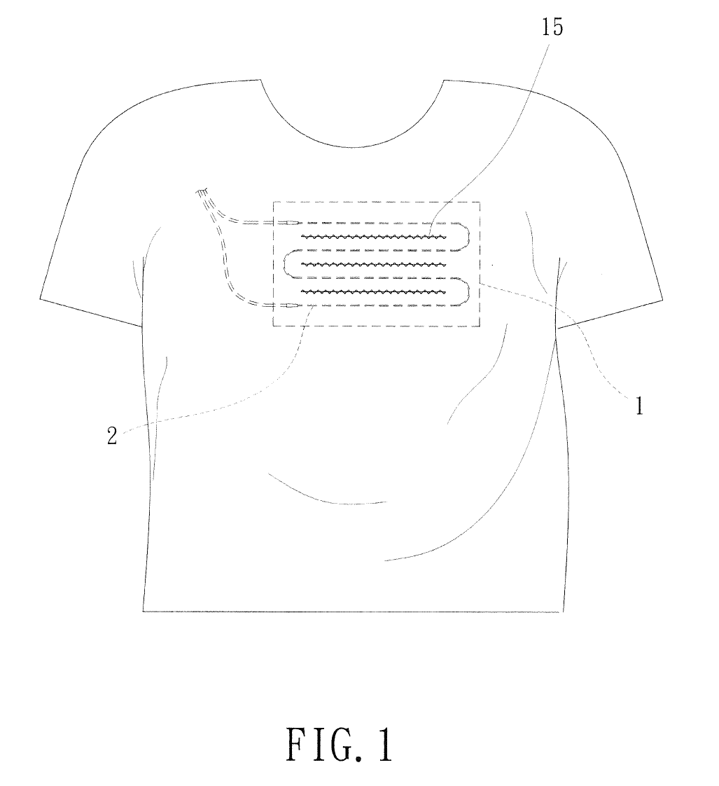

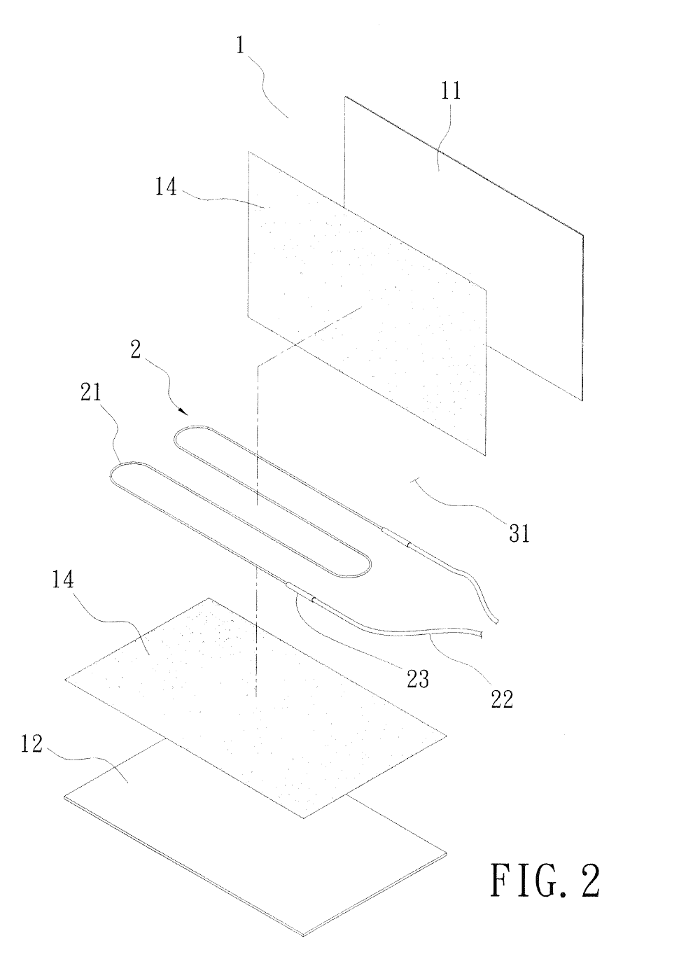

Refer to FIG. 1 and FIG. 2, a heater sewn on clothes according to the present invention includes a cover layer 1 and a heating unit 2.

The cover layer 1 consists of an inner layer 11, an outer layer 12 and an intermediate layer 13 formed between the inner layer 11 and the outer layer 12. One surface of the inner layer 11 and one surface of the outer layer 12 forming the intermediate layer 13 are respectively disposed with a waterproof membrane 14 having a high melting point. The waterproof membrane 14 is made of polyurethane. The thickness of the inner layer 11 is smaller than the thickness of the outer layer 12.

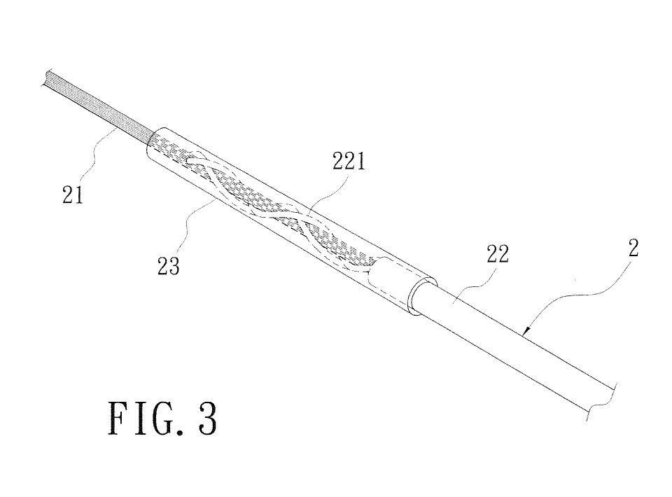

As shown in FIG. 2 and FIG. 3, the heating unit 2 is disposed in the intermediate layer 13 of the cover layer 1. The heating unit 2 is composed of a high resistance filament 21, conductive wires 22 connected to the high resistance filament 21 and a heat shrink sleeves 23. The high resistance filament 21 is made from metal or carbon fiber. One end of the conductive wire 22 connected to the high resistance filament 21 includes at least two strands of electric filaments 221 wound around the high resistance filament 21. Thus contact area between the electric filaments 221 of the conductive wire 22 and the high resistance filament 21 is increased. The heat shrink sleeve 23 made from soft and elastic material is wrapped around a contact point where the conductive wire 22 and the high resistance filament 21 are connected to each other, covering the contact point. Moreover, the other end of each conductive wire 22 is extended out from the cover layer 1 to be electrically connected with a controller and a power supply unit respectively.

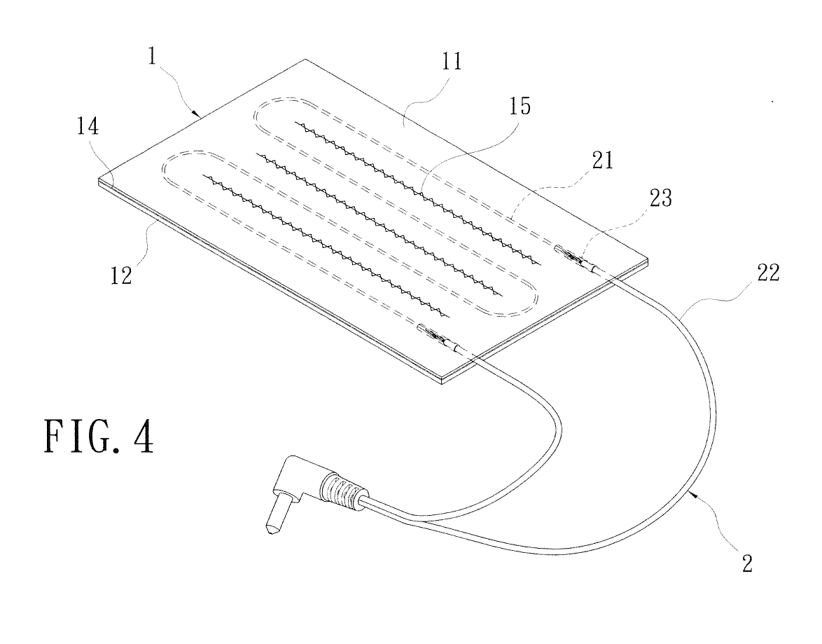

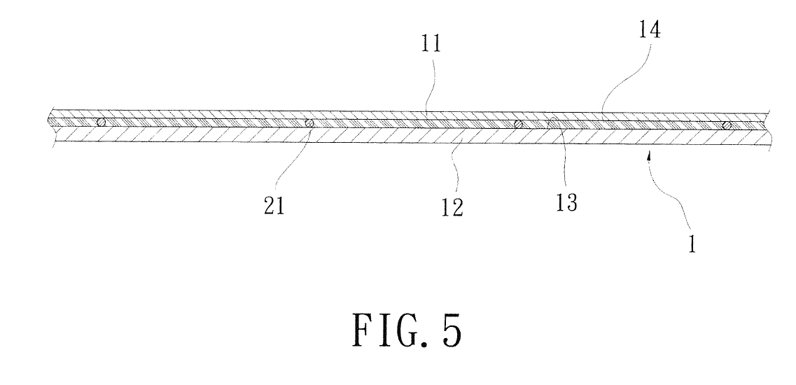

While being assembled, refer to FIG. 2 and FIG. 4, the high resistance filament 21 already connected with conductive wires 22 in advance is bent to form a plurality of portions arranged neatly on the waterproof membrane 14 of the inner layer 11 of the cover layer 1. Then one side of the outer layer 12 with the waterproof membrane 14 is covered over the high resistance filament 21. Thus the outer layer 12 is attached to the inner layer 11 and the high resistance filament 21 is mounted in the intermediate layer 13 formed between the outer layer 12 and the inner layer 11. Next high temperature and high pressure are applied to outer sides of the inner layer 11 and the outer layer 12 of the cover layer 1 so as to make the waterproof membranes 14 with the high melting point on the inner side of the inner layer 11 and of the outer layer 12 respectively melt, as shown in FIG. 5. Thus the inner layer 11 and the outer layer 12 of the cover layer 1 are connected to each other by the melt waterproof membrane 14. At the same time, the high resistance filament 21 in the intermediate layer 13 between the outer layer 12 and the inner layer 11 is also connected well with the waterproof membrane 14 being melted and is tightly fixed in the intermediate layer 13 of the cover layer 1 after the waterproof membrane 14 being cooled. Thereby water will not infiltrate into the contact point between the high resistance filament 21 and the conductive wire 22 due to the waterproof membrane 14. While the clothes being washed and scrubbed, the contact point between the high resistance filament 21 and the conductive wire 22 will not get damaged easily due to the heat shrink sleeve 23 wrapped the contact point between the conductive wire 22 and the high resistance filament 21. Later each of a plurality of dividing lines 15 is sewn between two adjacent parallel portions of the high resistance filament 21 on the cover layer 1 so as to separate the portions of the high resistance filament 21 from each other and avoid contact between the adjacent parallel portions of the high resistance filament 21 that reduces heating effect. The periphery of the inner layer 11 is sewn and connected to the periphery of the outer layer 12. The assembly of the cover layer 1 with the heating unit 2 is completed.

The assembled cover layer 1 and the heating unit 2 are sewn and fixed onto clothes, gloves, hats, shoes, etc. When people really feel cold in winder or bad weather and need to keep warm, they put on clothes with the present invention. Then the power supply unit is turned on by the controller and electric current is passed through the conductive wire 22 to flow through the high resistance filament 21. Thus the high resistance filament 21 gets heated up and a large amount of heat is produced. The heat is transferred to users' bodies through the cover layer 1. The heat from the high resistance filament 21 is transferred easier through the inner layer 11 as the sickness of the inner layer 11 of the cover layer 1 is smaller than the outer layer 12. Thus most of heat is delivered to warm up users' bodies. Moreover, the thicker outer layer 2 on the outer side is used for thermal insulation. Thereby energy saving is achieved.

Furthermore, the contact area between the conductive wire 22 and the high resistance filament 21 is significantly increased due to the strands of electric filaments 221 wound around the high resistance filament 21. Thus resistance at the contact point between the high resistance filament 21 and the conductive wire 22 is reduced while the current flowing through. Therefore hot spot heating will not occur and the current flows to the high resistance filament 21 effectively. The thermal efficiency of the high resistance filament 21 is improved.

In summary, the present invention has following advantages:

1. One side of the inner layer and one side of the outer layer of the cover layer are respectively disposed with a layer of the waterproof membrane having the high melting point. The sides of the inner layer and the outer layer with the waterproof membrane are placed facing each other and connected to form the intermediate layer for receiving the heating unit. While being assembled, the high resistance filament is bent and mounted in the intermediate layer. Then the inner and outer layers are treated by high temperature and high pressure for melting and connecting the waterproof membranes of the inner and the outer layers. The cover layer and the heating unit are assembled with each other quickly.
2. Due to high melting point, the waterproof membranes on the surfaces of the intermediate layer formed between the inner and the outer surfaces of the cover layer will not melt when the high resistance filament gets heated up. Thus the stable assembly of the cover layer with the high resistance filament and waterproof effect of the high resistance filament are ensured.
3. One end of the conductive wire of the heating unit is divided into a plurality of strands wound around and connected to the high resistance filament. Thus the contact area between the high resistance filament and the electric filament of the conductive wire is increased dramatically to reduce resistance on the contact point between the high resistance filament and the conductive wire. Thus the current flows to the high resistance filament smoothly and thermal efficiency of the heating unit is improved.
4. Due to smaller thickness of the inner layer than the outer layer of the cover layer, heat from the heating unit in the intermediate layer between the inner and outer layers is transferred through the thinner inner layer quickly. Thus most of the heat is delivered to and absorbed by the users. Safety in operation is assured.
5. Each parallel portion of the high resistance filament is separated exactly due to the dividing lines sewn between two adjacent parallel portions of the high resistance filament on the cover layer. Thereby the adjacent parallel portions of the high resistance filament will not contact each other while in use or being washed.
6. During washing and scrubbing, the contact point will not break or damage easily under influence of external forces because that the contact point between the high resistance filament and the conductive wire is protected by the heat shrink sleeve.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A heater sewn on clothes comprising: a cover layer, a heating unit; wherein the cover layer includes an inner layer, an outer layer and an intermediate layer formed between the inner layer and the outer layer; one surface of the inner layer forming the intermediate layer is disposed with a waterproof membrane having a high melting point and one surface of the outer layer forming the intermediate layer is arranged with a waterproof membrane having a high melting point; thickness of the inner layer is smaller than thickness of the outer layer;
the heating unit is arranged at the intermediate layer of the cover layer and is having a high resistance filament and conductive wires connected to the high resistance filament; the high resistance filament having a plurality of portions arranged neatly; one end of the conductive wire connected to the high resistance filament is divided into at least two strands of electric filaments, respectively wound around the high resistance filament while the other end of the conductive wire is extended out from the cover layer to be electrically connected with a controller and a power supply unit;
wherein a plurality of dividing lines is sewn on the cover layer and each dividing line is sewn between two adjacent portions of the high resistance filament.

2. The device as claimed in claim 1, wherein the waterproof membrane is made from polyurethane.

3. The device as claimed in claim 2, wherein the heating unit further includes a heat shrink sleeve wrapped around a contact point between the conductive wire and the high resistance filament.

4. The device as claimed in claim 1, wherein the heating unit further includes a heat shrink sleeve wrapped around a contact point between the conductive wire and the high resistance filament.

5. The device as claimed in claim 1, wherein the high resistance filament is made from carbon fiber.

6. The device as claimed in claim 1, wherein the high resistance filament is made from metal.
